(19) United States
(12) Patent Application Publication
(10) Pub. No.: US 2004/0135549 A1
(43) Pub. Date: Jul. 15, 2004

(54) Protection circuit for battery charge

(76) Inventors: Syoukou Chyou, Chiba-shi (JP); Atsushi Sakurai, Chiba-shi (JP)

Correspondence Address: ADAM & WILKS, 50 BROADWAY, 31st FLOOR, NEW YORK, NY, 10004, US

(21) Appl. No.: 10/670,809

(22) Filed: Sep. 25, 2003

(30) Foreign Application Priority Data
Sep. 27, 2002 (JP) 2002-283233

(51) Int. Cl. H02J 7/00

(52) U.S. Cl. 320/134

(57) ABSTRACT

To provide a protection circuit for battery charge and a power supply apparatus in which a wafer test period is shortened. The protection circuit for battery charge according to the present invention includes: a battery state monitoring circuit for monitoring a battery state of a secondary battery to output a battery state detection signal; an oscillation circuit for, in response to the battery state detection signal, outputting an output signal (CLK); a frequency division circuit for, in response to the output signal (CLK) from the oscillation circuit, outputting a frequency-divided signal; a logic circuit for, in response to the signal from the frequency division circuit, outputting a signal; a first terminal through which the output signal (CLK) from the oscillation circuit is inputted; a second terminal through which the signal from the logic circuit is inputted; and an external test circuit connected to the first terminal and the second terminal. The first terminal is connected to an input of the oscillation circuit.

### BACKGROUND OF THE INVENTION

1. Field of the Invention

The present invention relates to a circuit concerned with a test circuit which has a high speed measuring function when initial measurement and secondary measurement for a power supply circuit are carried out, and a protection circuit for battery charge adapted to utilize that circuit.

2. Description of the Related Art

First of all, the prior art will be described for the purpose of making the background of the present invention clear. FIG. 6 shows a configuration of a test circuit provided in a conventional protection circuit for battery charge (refer to JP 2001-283932 A (FIG. 2) for example). Usually, in the protection circuit for battery charge, an oscillation state of an oscillation circuit is controlled based on a battery state detection signal used to monitor a battery state of a chargeable secondary battery. FIG 7 shows a frequency of an output signal CLK from the oscillation circuit divided by a frequency division circuit to input an output signal from the frequency division circuit to a logic circuit. Then, the operation state and the basic functions of a battery state monitoring circuit and the oscillation circuit are monitored and confirmed on the basis of a signal inputted through an external terminal for testing provided in the logic circuit.

Here, when a period of the output signal CLK from the oscillation circuit is assigned Tclk, and the number of times of frequency division in the frequency division circuit is assigned n, a frequency of the signal which is frequency-divided by the frequency division circuit is expressed in the form of ½ⁿ of the oscillation frequency, and a period thereof is expressed in the form of Tclk×2ⁿ. In other words, when the operation state of the oscillation circuit is monitored and confirmed through the external terminal for testing, there is a delay time of Tclk×2ⁿ. A wafer test for semiconductor products consists of initial measurement and secondary measurement. At the time of the initial measurement, it is only necessary to confirm that a basic operation of the battery state monitoring circuit is normally carried out. On the other hand, at the time of the secondary measurement, since the trimming is carried out for circuits, not only the basis operation of the battery state monitoring circuit, but also the operation situations and the functions of the oscillation circuit and the frequency division circuit or the logic circuit or the like must be all confirmed.

In addition, confirmation is made through the external terminal for testing for both the initial measurement and the secondary measurement for a wafer test. Thus, a test period including the delay time caused in the frequency division circuit is long as described above, and this is one of the causes that increases a manufacturing cost of semiconductor products. In addition, in JP 2001-283932 A mentioned above, a test mode is described in which the delay time of an internal control circuit is shortened if a voltage equal to or higher than a regulated voltage is applied to a charger connection terminal of a charging type power supply apparatus. However, since the control system is different from that in the present invention and also the circuit concerned is not a dedicated test circuit, it is impossible to directly monitor the basic operation of the battery state monitoring circuit without causing a delay time.

As described above, the manufacturing cost of semiconductor products is influenced by a wafer test period, and the test period can not be further shortened in the prior art. As a result, it is difficult to realize reduction in manufacturing cost of semiconductor products.

### SUMMARY OF THE INVENTION

In light of the above, the present invention has been made in order to solve the above-mentioned problems associated with the prior art, and provides a protection circuit for battery charge that is capable of greatly shortening a test period as compared with the conventional circuit.

According to the present invention, at the time of initial measurement for a wafer test, an output terminal of an oscillation circuit provided in the conventional circuit is operatively connected to one external terminal for testing through a fuse, and the operation of the oscillation circuit which is controlled based on a battery state detection signal used to monitor a battery state of a chargeable secondary battery is monitored and confirmed without causing a delay time. In addition, at the time of secondary measurement for a wafer test, even after the fuse is cut off, the operation states and the functions of a battery state monitoring circuit, the oscillation circuit, a frequency division circuit or a logic circuit and the like are confirmed in a short period of time through the other external terminal for testing, by applying an external control signal to the oscillation circuit through the external terminal for testing to cause the oscillation circuit to oscillate a higher frequency signal. Thus, there is provided a test circuit for a protection circuit for battery charge that is capable of greatly shortening the conventional wafer test period.

According to the present invention, there is provided a protection circuit for battery charge, including: a battery state monitoring circuit for monitoring a battery state of a secondary battery to output a battery state detection signal; an oscillation circuit for, in response to the battery state detection signal, outputting an output signal CLK; a frequency division circuit for, in response to the output signal CLK from the oscillation circuit, outputting a frequency-divided signal; a logic circuit for, in response to the signal from the frequency division circuit, outputting a signal; a first terminal through which the output signal CLK from the oscillation circuit is inputted; a second terminal through which the signal from the logic circuit is inputted; and an external test circuit connected to the first terminal and the second terminal, in which the first terminal is connected to an input of the oscillation circuit.

The protection circuit for battery charge according to the present invention further includes a cut-off circuit for cutting off the output signal CLK from the oscillation circuit, which is provided between the oscillation circuit and the first terminal.

Further, according to the present invention, there is provided a protection circuit for battery charge, in which: at a time of initial measurement, an oscillation state of the oscillation circuit which is controlled based on the battery state detection signal is monitored through the first terminal; and at a time of secondary measurement, the output signal CLK from the oscillation circuit is cut off by the cut-off circuit, and an oscillation frequency of the oscillation circuit is accelerated with a signal inputted through the first terminal to shorten a delay time in the frequency division circuit, to thereby shorten a measurement time required to confirm operation states and functions of the battery state monitoring circuit, the oscillation circuit, the frequency division circuit or the logic circuit through the second terminal.

Further, according to the present invention, there is provided a power supply apparatus including the protection circuit for battery charge.

### BRIEF DESCRIPTION OF THE DRAWINGS

In the accompanying drawings:

FIG. 1 is a block diagram, partly in circuit diagram, showing a configuration of an embodiment of the present invention;

FIG. 2 is a block diagram, partly in circuit diagram, according to the present invention;

FIG. 3 is a waveform chart showing an output signal from an oscillation circuit in a normal case;

FIG. 4 is a waveform chart showing an output signal from an oscillation circuit at a time of initial measurement;

FIG. 5 is a waveform chart showing an output signal from an oscillation circuit at a time of secondary measurement;

FIG. 6 is a block diagram showing a configuration of a conventional circuit; and

FIG. 7 is a waveform chart useful in explaining confirmation of an operation of a conventional oscillation circuit.

### DETAILED DESCRIPTION OF THE PREFERRED EMBODIMENT

An embodiment of the present invention will hereinafter be described in detail with reference to the accompanying drawings.

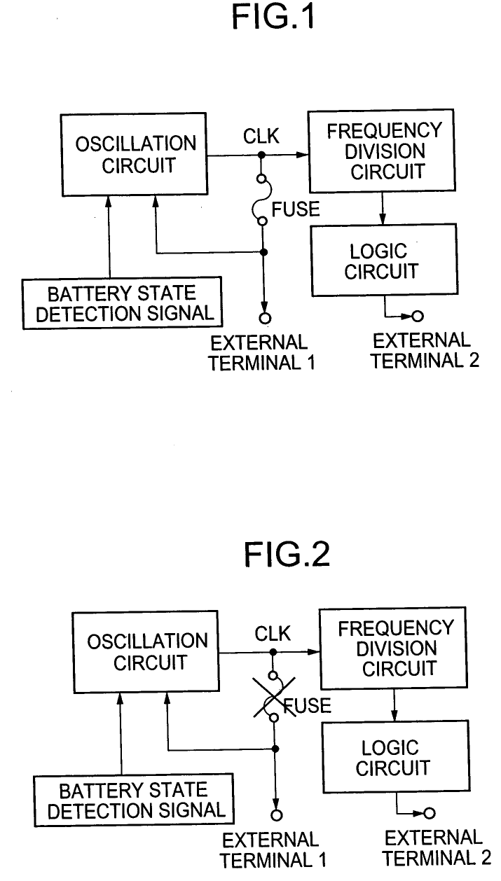

FIG. 1 shows a specific circuit configuration of a test circuit for a protection circuit for battery charge according to the present invention.

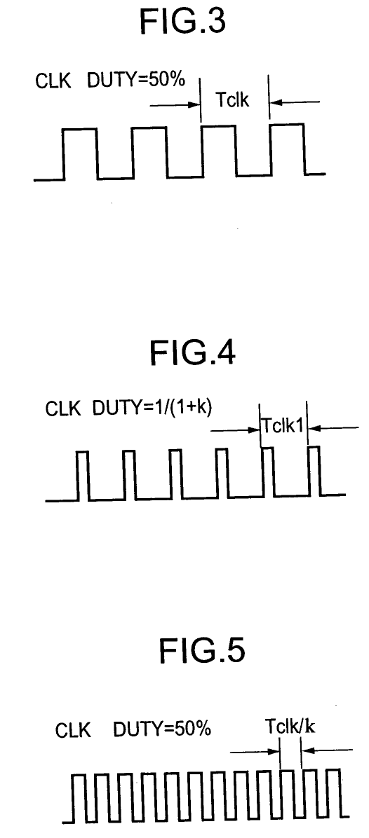

Usually, when initial measurement for a wafer test is carried out, an operation of an oscillation circuit is controlled based on a battery state detection signal from a battery state monitoring circuit for monitoring a battery state of a chargeable secondary battery, and an output signal CLK from the oscillation circuit serves as a control signal for the oscillation circuit as well through a fuse FUSE. Here, when the output signal CLK from the oscillation circuit is at the level LOW, it serves as a normal oscillation signal. On the other hand, when the output signal CLK from the oscillation circuit is at the level HIGH, the output signal CLK serves as a control signal to accelerate an oscillation frequency of the oscillation circuit. In this case, the output signal CLK does not become a normal oscillation signal as shown in FIG. 3, but becomes an accelerated oscillation signal from the oscillation circuit as shown in FIG. 4. When a period of the normal oscillation signal shown in FIG. 3 is assigned Tclk, and each of a period TL of time while the oscillation signal is at the level LOW and a period TH of time while the oscillation signal is at the level HIGH is assigned Tclk/2, a duty ratio in the normal state becomes 50%. In addition, an external terminal 1 for testing has a function as an external control terminal of the oscillation circuit. Hence, at the time when the level of the output signal from the oscillation circuit becomes HIGH, the oscillation frequency of the oscillation circuit is accelerated. At this time, when an acceleration magnification of the oscillation frequency is assigned k, the period TL of time while the oscillation signal is at the level LOW is not changed and hence is expressed as follows:

TL=Tclk/2 (Expression 1)

However, the period TH of time while the oscillation signal having the oscillation frequency accelerated by the magnification k is at the level HIGH is expressed as follows:

TH=Tclk/(2k) (Expression 2)

Thus, a period Tclk1 of the accelerated oscillation signal from the oscillation circuit shown in FIG. 4 is expressed as follows:

Tclk1=TL+TH=Tclk×(1+k)/(2k) (Expression 3)

Then, it is understood that since the magnification k is larger than 1, Tclk1 is smaller than Tclk, and hence the period is shortened. At this time, the duty ratio Duty is expressed as follows:

Duty=1/(1+k) (Expression 4)

In the case where the oscillation frequency is not accelerated, k is 1, and hence the duty ratio Duty is 50%. However, if the acceleration magnification k is set to 10, then the duty ratio Duty becomes 1/11, which is about 9.1%. But, in the case of the initial measurement for a wafer test, it is only necessary to confirm the oscillation operation of the oscillation circuit which is controlled based on the battery state detection signal from the battery state monitoring circuit for monitoring a battery state of the chargeable secondary battery. Hence, since the output signal CLK from the oscillation circuit is applied to the external terminal 1 for testing through the fuse FUSE and also can be directly confirmed through the external terminal 1 for testing without causing a delay time, a confirmation time is short. If m clocks need to be confirmed in order to confirm the operation of the oscillation circuit which is controlled based on the battery state detection signal from the battery state monitoring circuit, then a measurement time T1A in this embodiment is expressed as follows:

T1A=m×Tclk1=m×Tclk×(1+k)/(2k) (Expression 5)

However, in order to readily compare the measurement time TIA with the measurement time obtained at the conventional external terminal for testing, Tclk is used instead of Tclk1, ignoring the shortening, though Tclk1 is smaller than Tclk. Then the measurement time T1A of this embodiment is rewritten as follows:

T1A≡m×Tclk (Expression 6)

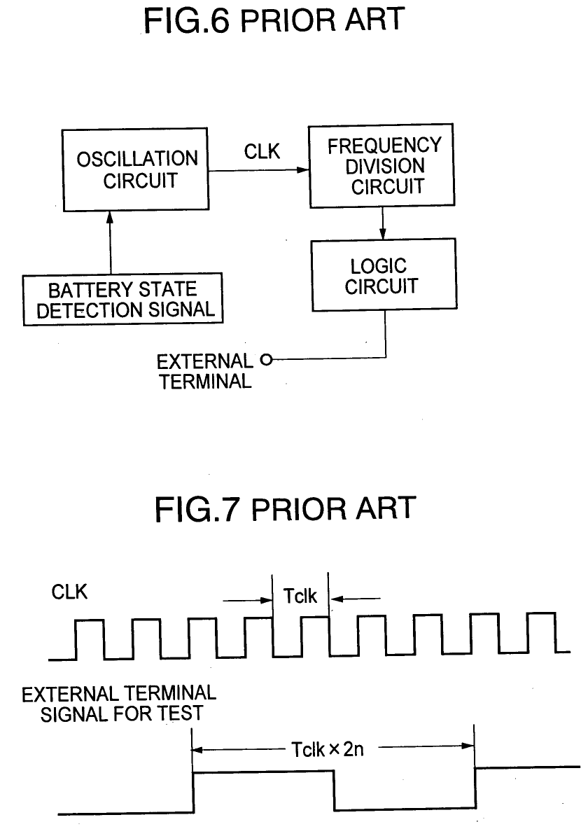

In addition, when the number of times of frequency division in the frequency division circuit is assigned n, the measurement time obtained at the conventional terminal for testing shown in FIG. 6 is expressed as follows:

T1B=m×Tclk×2ⁿ (Expression 7)

Thus, a shortened time DT1 is expressed as follows:

DT1=T1B−T1A=m×Tclk×(2ⁿ−1) (Expression 8)

Usually, since the number n of times of frequency division in the frequency division circuit is larger than 1, the measurement time T1A in this embodiment is so short, as compared with the shortened time DT1, that it can be ignored.

In addition, in the case where the secondary measurement is carried out, the fuse FUSE of the circuit shown in FIG. 1 is cut to provide a circuit shown in FIG. 2. The output signal CLK from the oscillation circuit which is controlled based on the battery state detection signal from the battery state monitoring circuit for monitoring the battery state of the chargeable secondary battery is frequency-divided by the frequency division circuit and then is applied to the external terminal 2 for testing via the logic circuit to be confirmed by the external terminal 2 for testing. Since a delay time is caused in the frequency division circuit, the measurement time is prolonged. However, by applying the control signal to the oscillation circuit through the external terminal 1 for testing to cause the oscillation circuit to oscillate a high frequency signal, a delay time caused in the frequency division circuit can be shortened.

If it is necessary to confirm m clocks in order to confirm the operations and the functions of the battery state monitoring circuit, the oscillation circuit and the frequency division circuit or the logic circuit and the like similarly to the initial measurement, the control signal is applied to the oscillation circuit through the external terminal 1 for testing to accelerate the oscillation frequency in this embodiment. Then, the resultant oscillation frequency becomes k times as high as the normal oscillation frequency. The accelerated oscillation frequency of the output signal CLK from the oscillation circuit is divided by the frequency division circuit to cause a delay time. However, since the resultant oscillation frequency becomes k times as high as the normal oscillation frequency, a period of a clock signal becomes 1/k of that in the normal case, i.e., Tclk/k (FIG. 5). Here, the measurement time T2A of this embodiment is expressed as follows:

T2A=m×Tclk×2ⁿ/k (Expression 9)

The measurement time obtained at the conventional external terminal for testing is expressed as usual as follows:

T2B=m×Tclk×2ⁿ (Expression 10)

As a result, the shortened time is expressed as follows:

DT2=T2B−T2A=m×Tclk×2ⁿ (1−1/k) (Expression 11)

Usually, since the acceleration magnification k is much larger than 1, the measurement time T2A in this embodiment is so short, as compared with the shortened time DT2, that it can be ignored.

Finally, when this embodiment is used, the initial measurement time for a wafer test becomes ½ⁿ and the secondary measurement time becomes 1/k. Accordingly, the whole test period can be greatly shortened as compared with the test periods obtained at the conventional external terminal for testing, and it is possible to reduce a manufacturing cost of semiconductor products.

As set forth hereinabove, according to the present invention, the output signal CLK from the oscillation circuit which is controlled based on the battery state detection signal from the battery state monitoring circuit for monitoring the battery state of the chargeable secondary battery is directly measured at the external terminal for testing. As a result, the measurement time becomes ½ⁿ of that measured at the conventional external terminal for testing, and the time of DT1 shown in Expression 8 is shortened. In addition, when the operation of the oscillation circuit is confirmed in the secondary measurement for a wafer test, the operation is confirmed at the external terminal 2 for testing. This is not different from the procedure for confirming the operation at the conventional external terminal for testing. However, in the present invention, the oscillation frequency of the oscillation circuit is accelerated up to k times as high as that the normal oscillation frequency in accordance with the control signal inputted through the external terminal 1 for testing, and the operations and the functions of the battery state monitoring circuit, the oscillation circuit and the frequency division circuit or the logic circuit and the like are confirmed at the other external terminal for testing. Hence, the measurement time becomes 1/k times as short as that measured in accordance with the conventional method. As a result, the time of DT2 shown in Expression 11 is shortened. Consequently, the time required for a wafer test of semiconductor products is greatly shortened, and a manufacturing cost or the like can also be reduced.

What is claimed is:

1. A protection circuit for battery charge, comprising:
a battery state monitoring circuit for monitoring a battery state of a secondary battery to output a battery state detection signal;
an oscillation circuit for, in response to the battery state detection signal, outputting an output signal (CLK);
a frequency division circuit for, in response to the output signal (CLK) from the oscillation circuit, outputting a frequency-divided signal;
a logic circuit for, in response to the signal from the frequency division circuit, outputting a signal;
a first terminal through which the output signal (CLK) from the oscillation circuit is inputted;
a second terminal through which the signal from the logic circuit is inputted; and
an external test circuit connected to the first terminal and the second terminal,
wherein the first terminal is connected to an input of the oscillation circuit.

2. A protection circuit for battery charge according to claim 1, further comprising a cut-off circuit for cutting off the output signal (CLK) from the oscillation circuit, which is provided between the oscillation circuit and the first terminal.

3. A protection circuit for battery charge, in which at a time of initial measurement, an oscillation state of the oscillation circuit which is controlled based on the battery state detection signal is monitored through the first terminal; and at a time of secondary measurement, the output signal (CLK) from the oscillation circuit is cut off by the cut-off circuit, and an oscillation frequency of the oscillation circuit is accelerated with a signal inputted through the first terminal to shorten a delay time in the frequency division circuit, to thereby shorten a measurement time required to confirm operation states and functions of the battery state monitoring circuit, the oscillation circuit, the frequency division circuit or a logic circuit through the second terminal.

4. A power supply apparatus, comprising the protection circuit for battery charge according to claim 1.

5. A power supply apparatus, comprising the protection circuit for battery charge according to claim 2.

6. A power supply apparatus, comprising the protection circuit for battery charge according to claim 3.
